(19) United States
(12) Patent Application Publication
(10) Pub. No.: US 2017/0308052 A1
(43) Pub. Date: Oct. 26, 2017

(54) CELL CONTROLLER FOR OPTIMIZING MOTION OF PRODUCTION SYSTEM INCLUDING INDUSTRIAL MACHINES

(71) Applicant: FANUC CORPORATION, Yamanashi (JP)

(72) Inventor: Takafumi KAJIYAMA, Yamanashi (JP)

(21) Appl. No.: 15/495,147

(22) Filed: Apr. 24, 2017

(30) Foreign Application Priority Data
Apr. 25, 2016 (JP) 2016-087171

(51) Int. Cl. G05B 19/402; G06F 9/455; G05B 19/416; G06N 99/00

(52) U.S. Cl. CPC G05B 19/402; G06N 99/005; G06F 9/455; G05B 19/416; G05B 2219/35311; G05B 2219/36252

(57) ABSTRACT

A cell controller capable of optimizing the operation of a production system having a plurality of industrial machines operated by an operation program. The cell controller includes: a system operational information analyzer configured to analyze time-series operational information received from the industrial machines via a network, so as to find a part in the system which generates an adverse effect on a cycle time of the entire production system; a state quantity analyzer configured to analyze a state quantity of the industrial machines so as to calculate a degree of margin of motion of each industrial machine; a program modifier configured to automatically modify a velocity or acceleration in the operation program based on the degree of margin; and a simulator configured to execute an operational simulation of the production system in order to confirm a modification result of the operation program.

### BACKGROUND OF THE INVENTION

### 1. Field of the Invention

The present invention relates to a cell controller for optimizing an operation of a production system including a plurality of industrial machines operated by a program.

### 2. Description of the Related Art

In the prior art, in a production system including a plurality of industrial machines such as industrial robots or CNC machine tools, various techniques have been proposed for speeding up the entire system. For example, JP 3946753 B discloses a method for evaluating and correcting a robot program, comprising the steps of: calculating a load of a motor for driving a movable part of a robot by a computer simulation; storing the motor load associated with commanded velocity and commanded acceleration of the motor; and judging the motor load by an evaluation function, as to whether or not the motor load exceeds an allowable value.

Further, JP H08-187648 A discloses a production line management system including a plurality of self-distributed cell unit controllers, and a management device communicably connected to each cell unit controller and configured to command a management condition. This document describes that the management device has: a virtual factory means for simulating a manufacturing process of a product manufactured by an actual plant by using a simulated programmable cell unit model of the actual plant controlled by each cell unit controller; and a management condition commanding means for downloading the management condition obtained by the virtual factory to each cell unit controller via a communication line.

When the production system is large and complicated, a huge amount of data is transmitted between the robot and the manufacturing machine. In such a case, is it difficult to judge which component of the production system is a bottleneck to speed-up the process in the entire system. Further, even when a component relating to the bottleneck is found, the bottleneck cannot be improved if the bottleneck is due to an upper limit of performance of the component, and thus it is necessary to find another bottleneck. It takes a lot of time to repeat such operations in order to improve the system.

The technique of JP 3946753 B is intended to evaluate the motor load of the robot by simulation of a computer, and optimally correct a robot program. In this method, the operation speed of the single robot may be increased, whereas the increase in the operation speed of the single robot does not always lead to increase in operation speed of the entire system, depending on the constitution of the system.

Further, the technique of JP H08-187648 A is intended to constitute a virtual production line, carry out a simulation of combinations of basic production elements; and determining the combination so that a cycle time is minimized. In this method, however, the basic production elements are combined, whereas the operation speed of each element such as the robot is not increased, and thus the operation speed of the entire production line is limited.

### SUMMARY OF THE INVENTION

Thus, an object of the present invention is to provide a cell controller capable of optimizing the operation of a production system having a plurality of industrial machines operated by an operation program.

To achieve the above object, one aspect of the present invention provides a cell controller for managing a production system having a plurality of industrial machines operated by an operation program, the cell controller comprising: a system operational information analyzer configured to analyze time-series operational information received from the industrial machines via a network, so as to find a part in the system which generates an adverse effect on a cycle time of the entire production system; a state quantity analyzer configured to analyze a state quantity including data of a sensor for detecting a state of the industrial machines, so as to calculate a degree of margin of motion of each industrial machine; a program modifier configured to automatically modify a velocity or acceleration in the operation program based on the degree of margin calculated by the state quantity analyzer; and a simulator configured to execute an operational simulation of the production system in order to confirm a modification result of the operation program.

The state quantity may include at least one of a velocity, acceleration, jerk, current, temperature, and a following error from a motor velocity command, of a motor mounted on the industrial machine.

The cell controller may further comprise a display configured to display a result of analysis by the system operational information analyzer and the state quantity analyzer, and a result of modification by the program modifier. In this case, the simulator may be configured to simulate an effect of improvement of the cycle time of the entire production system obtained by adding a function to the industrial machine, and a result of the simulation may be displayed on the display or a cloud server connected to the cell controller via a network.

The cell controller may further have a function for transmitting a result of analysis by the system operational information analyzer and the state quantity analyzer, and a result of modification by the program modifier, to a cloud server connected to the cell controller via a network.

The cell controller may further comprise a machine learning unit configured to learn a method for correcting the operation program based on outputs from the system operational information analyzer and the state quantity analyzer, and the machine learning unit may be configured to carry out reinforcement learning by adding a reward corresponding to the cycle time of the production system to a selected action.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is a functional block diagram showing a schematic configuration of a production system including a plurality of industrial machines and a cell controller according to an embodiment of the present invention;

FIG. 2 shows an example of a result of analysis by a system operational information analyzer of the cell controller of FIG. 1;

FIG. 3 shows another example of the result of analysis by the system operational information analyzer of the cell controller of FIG. 1; and

FIG. 4 shows an example of temporal change in a state quantity evaluated by a state quantity analyzer of the cell controller of FIG. 1.

### DETAILED DESCRIPTION

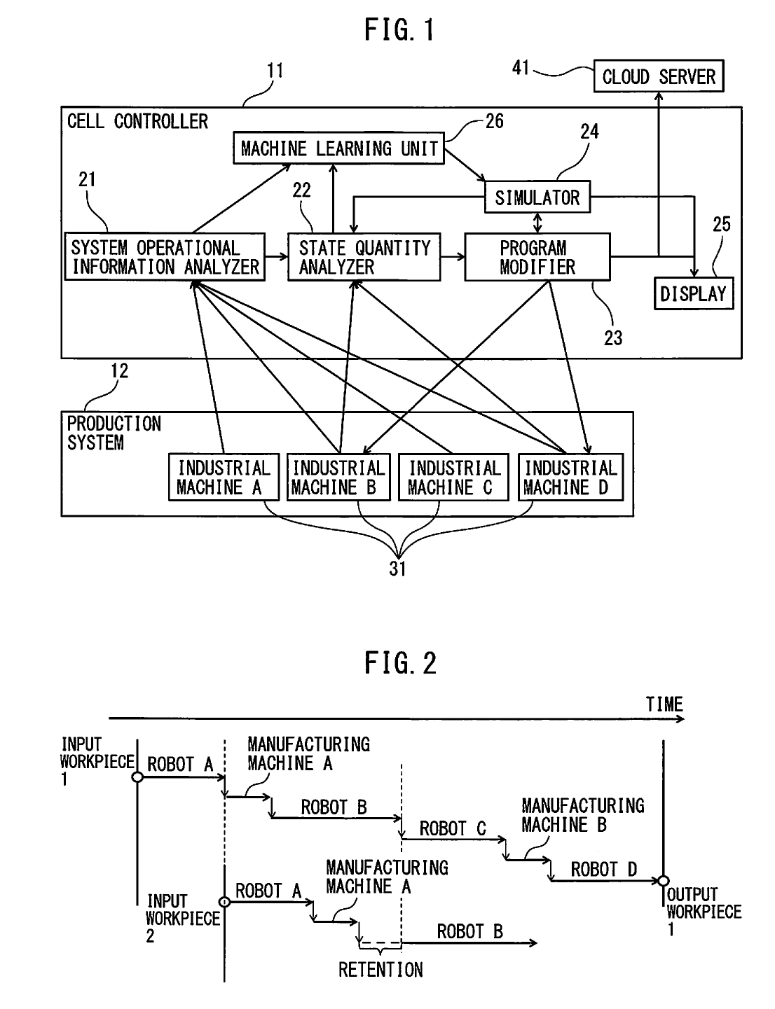

FIG. 1 is a function block diagram showing a schematic configuration of a production system 12 including a cell controller 11 according to an embodiment of the present invention, and a plurality of industrial machines managed by cell controller 11. Cell controller 11 has: a system operational information analyzer 21 configured to analyze time-series operational information (motion information) received from a plurality of (four in this embodiment) industrial machines 31 operated by an operation program via a network, so as to find a part in the system which generates an adverse effect on a cycle time (or takt time) of the entire production system 12; a state quantity analyzer 22 configured to analyze a state quantity including data of a sensor for detecting a state of industrial machines 31, so as to calculate a degree of margin of motion of each industrial machine 31; a program modifier 23 configured to automatically modify or improve a velocity or acceleration in the operation program based on the degree of margin calculated or output by state quantity analyzer 22; and a simulator 24 configured to execute an operational simulation of production system 12 in order to confirm a modification result of the operation program.

In the embodiment, the motion of each industrial machine 31 can be changed by the program, and a concrete example of industrial machine 31 may be an industrial robot, a CNC machine tool, or a manufacturing machine, etc.

For example, cell controller 11 may be an industrial PC (personal computer), and it is preferable that cell controller 11 be positioned separately from a controller (not shown) of industrial machine 31. When cell controller 11 is an independent hardware, it is not necessary to provide excess computing capability to the robot, the manufacturing machine or the controller thereof, whereby cost of the production system can be reduced. Further, production system 12 can be operated without using cell controller 11 after production system 12 is optimized, and then cell controller 11 can be efficiently used in order to speed up another production system. On the other hand, cell controller 11 may be incorporated, as a processor, etc., into the controller of industrial machine 31.

System operational information analyzer 21 is configured to receive time-series operational information from each industrial machine 31, and analyze the time-series operational information and a time schedule from inputting the workpiece into production system 12 to outputting the workpiece from the system, so as to find a bottleneck to speed-up the process in production system 12. For example, time-series operational information may include time-series I/O information and operating time information of the plurality of industrial machines.

FIG. 2 shows an example of a result of analysis by system operational information analyzer 21. In detail, FIG. 2 shows operations of robots A to D and manufacturing machines A and B in chronological order, from when first workpiece (workpiece 1) is input into the production system to when workpiece 1 is output (ejected) from the system after a series of manufacturing processes is finished. In FIG. 2, a solid line indicates an operating time of the robot or the manufacturing machine, and a dashed line indicates a retention time in which the workpiece is maintained without being processed or machined.

As shown in FIG. 2, in case that second workpiece (workpiece 2) is input into production system 12 when the operation (motion) of robot A for workpiece 1 is finished, a retention time may occur in which workpiece 2 is maintained without being processed until the operation of robot B for workpiece 1 is finished. Therefore, in this case, it is necessary to increase the working velocity of robot B in order to improve (reduce) the cycle time of production system 12.

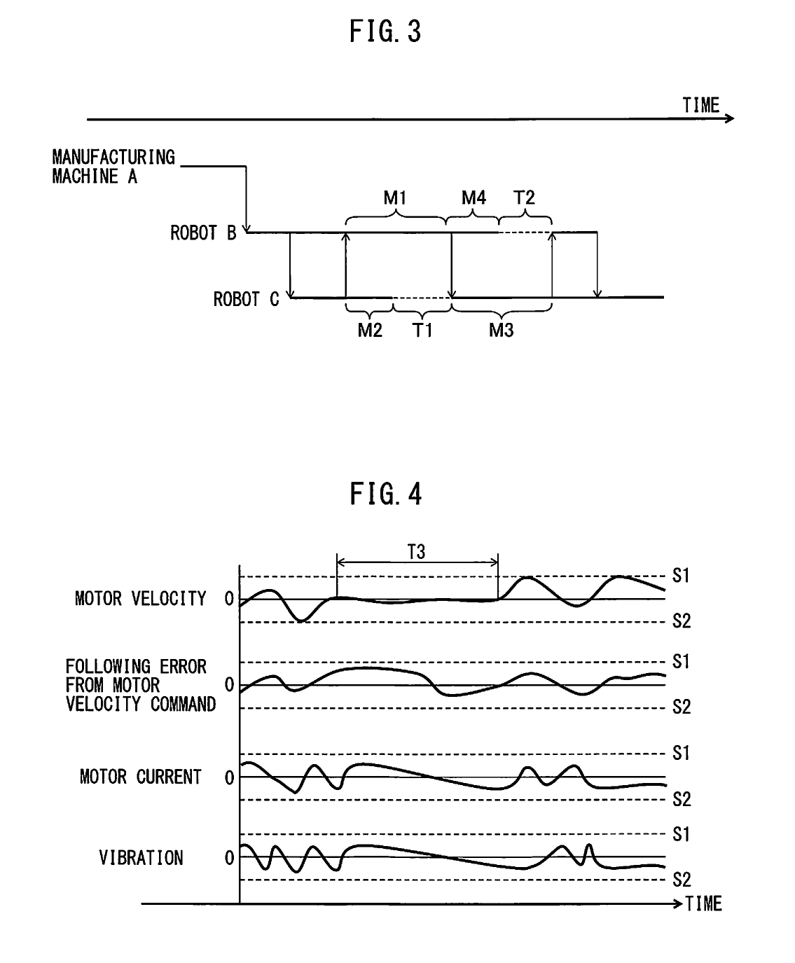

FIG. 3 shows another example of a result of analysis by system operational information analyzer 21. In detail, FIG. 3 shows a substantially one operation by robots B and C in chronological order, in which a workpiece or signal is transferred between robots B and C. In FIG. 3, a solid line indicates an operating time of the robot or the manufacturing machine, and a dashed line indicates a waiting time of the robot or the manufacturing machine, and an arrow indicates a timing of synchronization between the robots or between the robot and the manufacturing machine.

Although robots B and C are configured to carry out respective determined operations, one robot may wait the other robot at the timing of synchronization between the robots. In such a case, in order to speed up the system, it is necessary to analyze as to which robot has a longer operating time required until the robots must be synchronized, and then modify a part of the operation program of the robot having the longer operating time so as to improve the velocity of the robot.

In the example of FIG. 3, in order to reduce or eliminate waiting time T1 of robot C, it is effective to increase the working velocity of robot B within operating period of time M1. In other words, even when the operating period of time M2 of robot C is reduced, the waiting time of robot C cannot be reduced or eliminated. In addition, in order to reduce or eliminate waiting time T2 of robot B, it is effective to increase the working velocity of robot C within operating period of time M3. In other words, even when the operating period of time M4 of robot B is reduced, the waiting time of robot B cannot be reduced or eliminated.

As explained above, by analyzing the entire production system 12, the part in the system which generates the adverse effect on the cycle time can be clarified, and thus it can be judged as to which part in the system should be improved in order to streamline (or speed up) production system 12.

With respect to the part of the operation program to be speeded up analyzed by system operational information analyzer 21, state quantity analyzer 22 collects and analyzes a quantity of state (or state quantity) of industrial machine 31 so as to calculate a degree of margin. For example, at least one of a velocity, acceleration, jerk, torque, current, temperature, and a following error from a motor velocity command, of the motor equipped or mounted on industrial machine 31, may be included in the state quantity collected by state quantity analyzer 22 from industrial machine 31. Further, these parameters may be combined so as to introduce a new kind of state quantity (for example, an oscillating quantity may be estimated from the acceleration and the jerk of the motor). These state quantities may be collected in chronological order.

FIG. 4 shows an example of temporal change in the state quantity evaluated by state quantity analyzer 22. As shown in FIG. 4, each state quantity may have a threshold (for example, upper limit S1 and lower limit S2). In this case, it can be judged that the state quantity has a margin when said state quantity does not exceed the threshold, and thus the component such as the motor associated with the state quantity can be speeded up. For example, the threshold of the motor velocity may be determined based on a specification of the motor. In this regard, when the motor velocity does not reach the threshold (or the upper limit), it can be judged that the motor velocity can be speeded up from the current state. Otherwise, in case that the vibration is estimated from the acceleration, when the vibration quantity has a margin to the threshold (or the upper limit), it can be judged that the acceleration can be speeded up from the current state. As such, by obtaining the time-series data of each state quantity, it can be judged as to whether each parameter (such as the velocity, acceleration, jerk, etc.) has a sufficient margin or not.

Hereinafter, an example for speeding up production system 12 based on the margin (or the difference between the threshold and the current value) of the state quantity will be explained. First, state quantity analyzer 22 calculates a temporal integrated value of the time-series data of each state quantity as exemplified in FIG. 4, and calculates a period of time in which the margin (or a moving average thereof) of each state quantity is relatively large. For example, in FIG. 4, the margin of the motor velocity is relatively large in a period of time T3, since the motor velocity is approximately zero in this period of time.

Next, from the information regarding the period of time in which the margin (or the moving average thereof) for speeding up the system obtained by the analysis result of state quantity analyzer 22, program modifier 23 automatically selects the part of the program corresponding to the period of time, and automatically corrects the part of the program for speeding up the system. Concretely, program modifier 23 corrects a motion command included in the program part so that a velocity command value or an acceleration command value is increased.

In this regard, simulator 24 may be used to confirm or monitor a change in the cycle time or a change in the state quantity (such as the motion velocity) of the industrial machine, as a result of correction of the program. Simulator 24 simulates the motion of industrial machine 31 based on the modified operation program from program modifier 23, confirms that the cycle time is reduced, and calculates the state quantity (such as the motor velocity or acceleration) corresponding to the modified operation program. As required, the state quantity may be input into state quantity analyzer 22 again and the output of analyzer 22 may be transmitted to program modifier 23 again, whereby the operation program can be iteratively improved. In this regard, if the state quantity of the industrial machine calculated by simulator 24 exceeds the threshold as shown in FIG. 4 in the repetitive process, the program modification of the part of the program may be terminated without utilizing the latest operation program.

The modified operation program as explained above is transmitted to (the controller of) each industrial machine 31 from program modifier 23, whereby the operation program of each industrial machine is automatically updated. This update process may be periodically carried out at predetermined time intervals, or may be carried out at a timing designated by the user. Further, the modification of the operation program may not be automatically validated, instead, the modification may be informed to the user by using a display 25, and then the modification may be validated after the user approves the modification. Display 25 may display the result of analysis by system operational information analyzer 21 and state quantity analyzer 22, and the result of modification by program modifier 23.

As shown in FIG. 1, the information obtained in cell controller 11 may be transmitted to a cloud server 41 which corresponds to a host or supervisory computer of cell controller 11. By connecting cloud server 41 and a plurality of cell controllers via a network, the information regarding the plurality of cell controllers can be integrally processed or analyzed, whereby the production system constituted by the cell controllers can be totally optimized.

The information of cloud server 41 may be observed by the user via an external network. By virtue of this, the status of the modification of the motion and/or the validation of the modified program can be remotely judged or operated. Further, the information of cloud server 41 may be disclosed to an industrial equipment maker or a system integrator. By virtue of this, the maker can check or diagnose the operation of the production system, and propose the improvement of the system, whereby the production system can be further streamlined.

At least one of industrial machines 31 may include software for adding a function for speeding up the motion of the industrial machine. In such a case, simulator 24 may simulate an effect in adding the new software, concretely, an effect of improvement of the cycle time of the entire production system 12 including industrial machine 31. Then, a result of the simulation may be informed to the user by being displayed on display 25 or cloud server 41. By virtue of this, the user can easily judge cost-effectiveness of software option.

In fact, the first workpiece (workpiece 1) may not be always input into production system 12 at regular time intervals. Further, as shown in FIG. 2, the process of workpiece 2 has the retention time, but the process of workpiece 1 does not have it. In other words, even when the workpieces are input into the system at the same time intervals, the part in the system corresponding to the bottleneck may be different depending on the workpiece. In such a case, the workpieces may be input into the system several times and the program may be modified each time, and results of these processes may be recorded, whereby a statistically optimized modification of the program can be determined.

In the above embodiment, the operation program of the industrial machine is modified so as to speed up the machine. However, with respect to a part of the production system which does not generate an adverse effect on the cycle time, the velocity of the motion of the industrial machine may be decreased. By virtue of this, a mechanical life of the industrial machine can be lengthened, a power consumption, noise, and probability of overheat of the machine can be reduced. As such, when the production system includes one part to be speeded up and the other part to be slowed down, the motion of the entire system can be optimized.

As shown in FIG. 1, cell controller 11 may have a machine learning unit 26 configured to carry out learning (for example, reinforced learning), based on the outputs from system operational information analyzer 21 and state quantity analyzer 22, in order to obtain the modified operation program, and then transmit a result of the learning to simulator 24.

As an example of the reinforced learning by machine learning unit 26, a Q learning will be explained below. The Q learning is a method of learning value Q (s, a) for selecting a motion (action) “a” under a certain environment state “s.” In other words, under the certain state “s,” an action “a” having the highest value Q (s, a) may be selected as the optimal action. However, at the beginning, with respect to a combination of state “s” and action “a,” a correct value of value Q (s, a) is completely unknown. Then, an agent (subject of action) selects various actions “a” under certain state “s,” and rewards are provided to actions “a” at that time. Thereby, the agent learns selection of a better action, i.e., correct value Q (s, a).

When the Q learning is applied to the above embodiment, state quantity “s” is constituted by the outputs of system operational information analyzer 21 and state quantity analyzer 22. The action “a” corresponds to a modification command to the operation program. For example, when a line “Y” in a program “X” should be modified by using a value “Z,” the action “a” can be represented as a vector including components X, Y and Z. Then, value function Q (s, a), constituted by “s” and “a,” is repeatedly learned while adding the reward to the function. For example, when the cycle time is relatively short, a plus reward is added to the selected action. On the other hand, when the state quantity is excessively larger than a threshold, a minus reward is added to the selected action. By virtue of this, the action in which the cycle time is optimally short can be learned, while satisfying of a limiting condition of the state quantity.

Further, in order to maximize a total sum of rewards obtained over the future as a result of actions, an object is to finally have Q (s, a)=E[Σ γ^{t} rₜ]. In this regard, “E,” “t,” “γ,” “rₜ” and “Σ” represent an expectation value, a time point, a parameter referred to as a discount percentage as described below, a reward at time point t, and a total sum at time point t, respectively. The expectation value is obtained when the state is changed in accordance with an optimal action. Of course, this is unknown and thus learning is to be performed while performing searching. An update equation of such value Q (s, a) may be represented by following equation (1).

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

In above equation (1), “sₜ” represents the state of the environment at time point t, and “aₜ” represents an action at time point t. By action at, the state changes into sₜ₊₁. “rₜ₊₁” represents a reward obtained by the change of the state. Meanwhile, the term provided with “max” is one in which Q value when action “a” having the highest Q value known at that time is selected under state sₜ₊₁ is multiplied by γ. In this regard, γ is a parameter within 0<γ≦1 and called as the discount percentage, and α is a learning coefficient within 0<α≦1.

As explained above, machine learning unit 26 learns the method for correcting the operation program based on the outputs from system operational information analyzer 21 and state quantity analyzer 22. Concretely, machine learning unit 26 carries out the reinforcement learning by adding the reward corresponding to the cycle time of production system 12 to the selected action. Generally, the machine learning needs a large number of trial-and-error calculations. However, in the embodiment, the simulation of the cycle time can be executed without operating an actual system, the reward can be rapidly calculated, whereby the learning can also be rapidly executed.

According to the present disclosure, the operational information can be received from the plurality of industrial machines, the motion of which can be changed by the program; the bottleneck of the production system can be analyzed; the part of the operation program regarding the speed up of the system can be extracted based on the result of analysis; and the part of the program can be automatically corrected. Therefore, the production system can be efficiently speeded up.

While the invention has been described with reference to specific embodiments chosen for the purpose of illustration, it should be apparent that numerous modifications could be made thereto, by a person skilled in the art, without departing from the basic concept and scope of the invention.

1. A cell controller for managing a production system having a plurality of industrial machines operated by an operation program, the cell controller comprising:
a system operational information analyzer configured to analyze time-series operational information received from the industrial machines via a network, so as to find a part in the system which generates an adverse effect on a cycle time of the entire production system;
a state quantity analyzer configured to analyze a state quantity including data of a sensor for detecting a state of the industrial machines, so as to calculate a degree of margin of motion of each industrial machine;
a program modifier configured to automatically modify a velocity or acceleration in the operation program based on the degree of margin calculated by the state quantity analyzer; and
a simulator configured to execute an operational simulation of the production system in order to confirm a modification result of the operation program.

2. The cell controller as set forth in claim 1, wherein the state quantity includes at least one of a velocity, acceleration, jerk, current, temperature, and a following error from a motor velocity command, of a motor mounted on the industrial machine.

3. The cell controller as set forth in claim 1, further comprising a display configured to display a result of analysis by the system operational information analyzer and the state quantity analyzer, and a result of modification by the program modifier.

4. The cell controller as set forth in claim 3, wherein the simulator is configured to simulate an effect of improvement of the cycle time of the entire production system obtained by adding a function to the industrial machine, and a result of the simulation is displayed on the display or a cloud server connected to the cell controller via a network.

5. The cell controller as set forth in claim 1, wherein the cell controller has a function for transmitting a result of analysis by the system operational information analyzer and the state quantity analyzer, and a result of modification by the program modifier, to a cloud server connected to the cell controller via a network.

6. The cell controller as set forth in claim 1, further comprising a machine learning unit configured to learn a method for correcting the operation program based on outputs from the system operational information analyzer and the state quantity analyzer, wherein the machine learning unit is configured to carry out reinforcement learning by adding a reward corresponding to the cycle time of the production system to a selected action.
